(19) United States
(12) Patent Application Publication
(10) Pub. No.: US 2023/0023222 A1
(43) Pub. Date: Jan. 26, 2023

(54) BOIL-OFF GAS TREATMENT SYSTEM AND METHOD FOR FUEL CELL ELECTRIC VEHICLE

(71) Applicants: Hyundai Motor Company, Seoul (KR); Kia Corporation, Seoul (KR)

(72) Inventor: Soon Ho Kwon, Yongini (KR)

(21) Appl. No.: 17/870,359

(22) Filed: Jul. 21, 2022

(30) Foreign Application Priority Data
Jul. 21, 2021 (KR) 10-2021-0095248

(51) Int. Cl. B60L 58/30; F17C 5/00; H01M 8/04082; H01M 8/0438

(52) U.S. Cl. CPC B60L 58/30; F17C 5/007; H01M 8/04082; H01M 8/04432; F17C 2221/012; F17C 2250/043; F17C 2260/03; F17C 2270/0184; H01M 2250/20

(57) ABSTRACT

The present disclosure relates to a boil-off gas treatment system and method for a fuel cell electric vehicle, and a main object of the present disclosure is to provide a boil-off gas treatment system and method capable of safely and efficiently treating, storing, and utilizing vaporized hydrogen in a hydrogen tank for a fuel cell electric vehicle.

### CROSS-REFERENCE TO RELATED APPLICATION

This application is based on and claims under 35 U.S.C. §119(a) the benefit of Korean Patent Application No. 10-2021-0095248 filed on Jul. 21, 2021, the entire contents of which are incorporated herein by reference.

### TECHNICAL FIELD

Embodiments of the present disclosure relate to a boil-off gas treatment system and method for a fuel cell electric vehicle, and more particularly, to a boil-off gas treatment system and method capable of safely and efficiently treating, storing, and utilizing hydrogen vaporized in a hydrogen tank of a fuel cell electric vehicle.

### BACKGROUND

A fuel cell refers to a power generation device that converts chemical energy of fuel into electrical energy by using an electrochemical reaction between fuel gas and oxidant gas. The fuel cells are widely used to provide power for industrial and domestic purposes, power used for a vehicle, and power used for small-scale electric and/or electronic products and mobile devices. Research is being most actively conducted on a polymer electrolyte membrane fuel cell, as a fuel cell for a vehicle, which has high power density. The polymer electrolyte membrane fuel cell uses hydrogen as fuel gas and oxygen or air containing oxygen as oxidant gas.

The fuel cell may include a plurality of unit cells each configured to produce electrical energy by using a reaction between fuel gas and oxidant gas. To meet a required output level, a stack made by stacking the plurality of unit cells and connecting the stacked plurality of unit cells in series is generally used. A fuel cell mounted in a vehicle also requires a high output. Therefore, the fuel cell is made by stacking several hundreds of unit cells, which independently produce electrical energy, in the form of a stack to meet the requirement. A cell assembly, which is made by stacking and connecting the plurality of unit cells as described above, is called a fuel cell stack.

A fuel cell system mounted in a fuel cell electric vehicle includes the fuel cell stack and devices for supplying reactant gas to the fuel cell stack. That is, the fuel cell system includes the fuel cell stack configured to generate electrical energy through an electrochemical reaction of the reactant gas, a hydrogen supply device configured to supply hydrogen, which is fuel gas, to the fuel cell stack, an air supply device configured to supply air containing oxygen, which is oxidant gas, to the fuel cell stack, heat and water management systems configured to control an operating temperature of the fuel cell stack and manage heat and water, and a fuel cell control unit (FCU) configured to control an overall operation of the fuel cell system.

In addition, since the fuel cell electric vehicle uses hydrogen as fuel gas, the fuel cell system is essentially equipped with a hydrogen storage system configured to store hydrogen. A high-pressure hydrogen tank capable of being charged with and storing high-pressure hydrogen is widely used as the hydrogen storage system for a fuel cell electric vehicle. The fuel cell electric vehicle equipped with the hydrogen tank needs to be periodically charged with hydrogen at a charging station. The hydrogen tank is typically charged with hydrogen pressurized in a high-pressure state. In this case, the hydrogen tank stores liquid hydrogen.

In addition, vaporized hydrogen, i.e., boil-off gas (BOG), which is made when the liquid hydrogen is vaporized, is present in the hydrogen tank. Typically, a pressure in the hydrogen tank is maintained by removing the boil-off gas to the outside when a pressure of the boil-off gas (vaporized hydrogen) in the hydrogen tank is equal to or higher than a predetermined pressure.

FIG. 1 is a view schematically illustrating a hydrogen storage system including a hydrogen tank. As illustrated, in the fuel cell electric vehicle, hydrogen in a hydrogen tank 1 is supplied in a gaseous state to a fuel cell stack through a supply valve 2.

In addition, a pressure relief valve (PRV) 3 is installed on the hydrogen tank 1. The pressure relief valve serves to discharge vaporized hydrogen in the hydrogen tank to the outside when the pressure in the hydrogen tank becomes equal to or higher than a predetermined pressure because of the vaporized hydrogen produced in the hydrogen tank. However, if hydrogen is discharged directly to the outside, there is a risk of ignition and explosion, and it is difficult to meet related regulations that restrict concentration of hydrogen discharged into the atmosphere.

Therefore, there is sometimes applied a technology in which a treatment device configured to oxidize or combust hydrogen by using an oxidation catalyst or the like is disposed at an outlet side of the pressure relief valve 3 and the hydrogen discharged through the pressure relief valve is removed by the treatment device. However, both the technology for discharging hydrogen into the atmosphere by installing the pressure relief valve and the technology for removing hydrogen by oxidizing or combusting the hydrogen remove the vaporized hydrogen in the hydrogen tank 1 without using the vaporized hydrogen, which causes a problem of a loss of energy.

Therefore, as illustrated in FIG. 2, there is sometimes used a system 4 that uses a refrigeration cycle and cools and reliquefies hydrogen discharged from the hydrogen tank 1 through the pressure relief valve 3. However, since the system uses separate power to reliquefy the vaporized hydrogen and then circulate the reliquefied hydrogen to the hydrogen tank, the configuration of the system is complicated, and a significant loss of energy occurs during the reliquefication. In addition, because large-scale hardware and facility are required, the system cannot be utilized for a vehicle but can be used only for a large-scale ship or a large-scale plant.

The above information disclosed in this Background section is only for enhancement of understanding of the background of the invention and therefore it may contain information that does not form the prior art that is already known in this country to a person of ordinary skill in the art.

### SUMMARY

Embodiments of the present disclosure provide a boil-off gas treatment system and method capable of safely and efficiently treating, storing, and utilizing vaporized hydrogen in a hydrogen tank for a fuel cell electric vehicle.

In one aspect, a boil-off gas treatment system for a fuel cell electric vehicle is provided, the system suitably may comprise: a) a hydrogen storage unit configured to separately store 1) liquid hydrogen and 2) hydrogen in a gaseous state, and the hydrogen storage unit comprising a state detector that is configured to detect an internal state of a storage space that stores the gaseous hydrogen; b) a controller configured to output a control signal for idling the fuel cell stack by supplying the fuel cell stack with the gaseous hydrogen in the storage space when the internal state of the storage space detected by the state detector satisfies a predetermined condition in a state in which a vehicle is turned off; and c) a supply valve installed at an outlet side of he hydrogen storage unit connected to the fuel cell stack, the supply valve being configured to be opened on the basis of a control signal outputted by the controller in order to supply the gaseous hydrogen when the fuel cell stack idles.

The gaseous hydrogen suitably may be vaporized from liquid hydrogen that is being utilized in conjunction with the system. Gaseous hydrogen is sometimes referred to herein as vaporized hydrogen.

An exemplary embodiment of the present disclosure provides a boil-off gas treatment system for a fuel cell electric vehicle, the boil-off gas treatment system including: a hydrogen storage unit configured to separately store liquid hydrogen and hydrogen vaporized from the liquid state in a state in which the hydrogen storage unit is charged with hydrogen to be used as fuel for a fuel cell stack; a state detector installed in the hydrogen storage unit and configured to detect an internal state of a storage space that stores the vaporized hydrogen; a controller configured to output a control signal for idling the fuel cell stack by supplying the fuel cell stack with the vaporized hydrogen when the internal state of the storage space detected by the state detector satisfies a predetermined condition in a state in which a vehicle is turned off; and a supply valve installed at an outlet side of the storage space of the hydrogen storage unit connected to the fuel cell stack, the supply valve being configured to be opened on the basis of a control signal outputted by the controller in order to supply the vaporized hydrogen when the fuel cell stack idles.

Further, another exemplary embodiment of the present disclosure provides a boil-off gas treatment method for a fuel cell electric vehicle, the boil-off gas treatment method including: storing, by a hydrogen storage unit, hydrogen vaporized from liquid hydrogen in a separate storage space of the hydrogen storage unit in a state in which the hydrogen storage unit is charged with hydrogen used as fuel for a fuel cell stack; detecting, by a state detector installed in the hydrogen storage unit, an internal state of the storage space in which the vaporized hydrogen is stored; outputting, by a controller, a control signal for idling the fuel cell stack by supplying the fuel cell stack with the vaporized hydrogen in the storage space when the internal state of the storage space detected by the state detector satisfies a predetermined condition in a state in which a vehicle is turned off; and opening a supply valve installed at an outlet side of the storage space connected to the fuel cell stack and idling the fuel cell stack by hydrogen supplied from the storage space on the basis of the control signal outputted from the controller.

Therefore, according to the boil-off gas treatment system and method for a fuel cell electric vehicle according to embodiments of the present disclosure, it is possible to safely and efficiently treat, store, and utilize hydrogen vaporized in the hydrogen tank of the fuel cell electric vehicle.

In addition, according to embodiments of the present disclosure, it is possible to collectively control recirculation of liquid hydrogen and gaseous hydrogen (boil-off gas) and recover and use the total amount of gaseous hydrogen that was removed from the fuel cell electric vehicle in the related art. Therefore, it is possible to improve efficiency in using energy and improving vehicle fuel economy.

As discussed, the method and system suitably include use of a controller or processor.

In another embodiment, vehicles are provided that comprise a boil-off gas treatment system as disclosed herein.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view schematically illustrating a hydrogen storage system including a hydrogen tank;

FIG. 2 is a view illustrating an example of a boil-off gas treatment system in the related art;

FIG. 3 is a view illustrating a configuration of a boil-off gas treatment system according to an exemplary embodiment of the present disclosure;

FIG. 4 is a view illustrating a coolant circulation path in a fuel cell electric vehicle to which the boil-off gas treatment system according to the embodiment of the present disclosure is applied; and

FIGS. 5A and 5B are flowchart illustrating a boil-off gas treatment method according to an exemplary embodiment of the present disclosure.

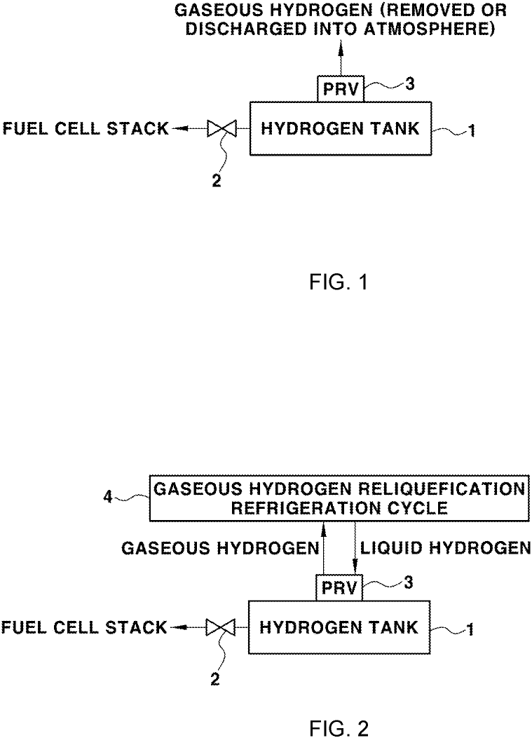

It should be understood that the appended drawings are not necessarily to scale, presenting a somewhat simplified representation of various features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several Figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Specific structural and functional descriptions suggested in embodiments of the present disclosure are exemplified only for the purpose of explaining embodiments according to the concept of the present disclosure, and the embodiments according to the concept of the present disclosure may be carried out in various forms. In addition, the present disclosure should not be interpreted as being limited to the embodiments disclosed in the present specification, and it should be understood that the present disclosure includes all modifications, equivalents, and alternatives included in the spirit and the technical scope of the present disclosure.

Meanwhile, the terms such as “first” and/or “second” in the present disclosure may be used to describe various constituent elements, but these constituent elements should not be limited by these terms. These terms are used only for the purpose of distinguishing one constituent element from other constituent elements. For example, without departing from the scope according to the concept of the present disclosure, a first constituent element may be referred to as a second constituent element, and similarly, the second constituent element may also be referred to as the first constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

Like reference numerals indicate like constituent elements throughout the specification. The terms used in the present specification are for explaining the embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude presence or addition of one or more other constituent elements, steps, operations, and/or elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the embodiments of the present disclosure will be described in detail with reference to the accompanying drawings.

The present disclosure relates to a boil-off gas treatment system and method applied to a fuel cell electric vehicle and provides a boil-off gas treatment system and method capable of safely and efficiently treating, storing, and utilizing vaporized hydrogen in a hydrogen tank for a fuel cell electric vehicle.

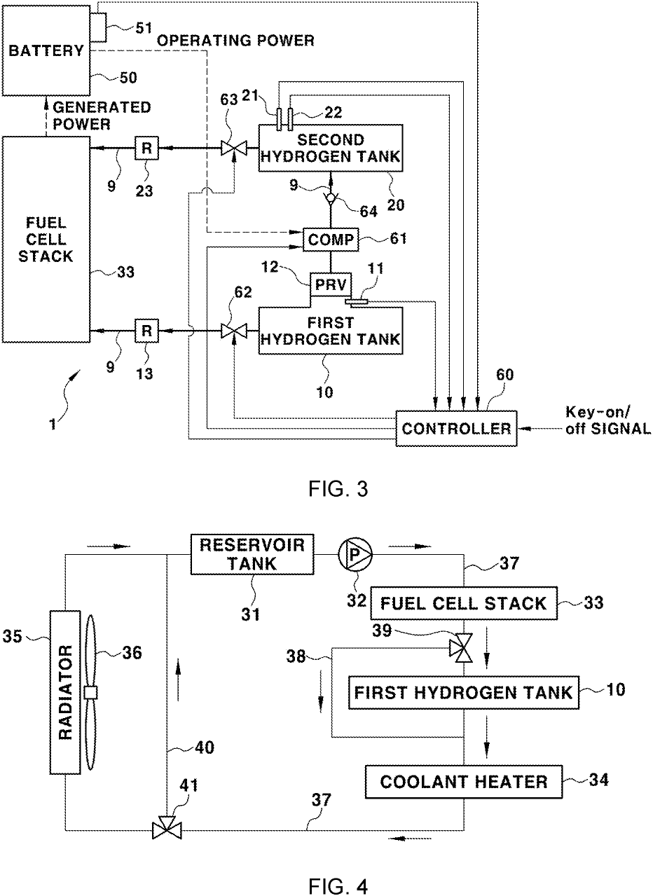

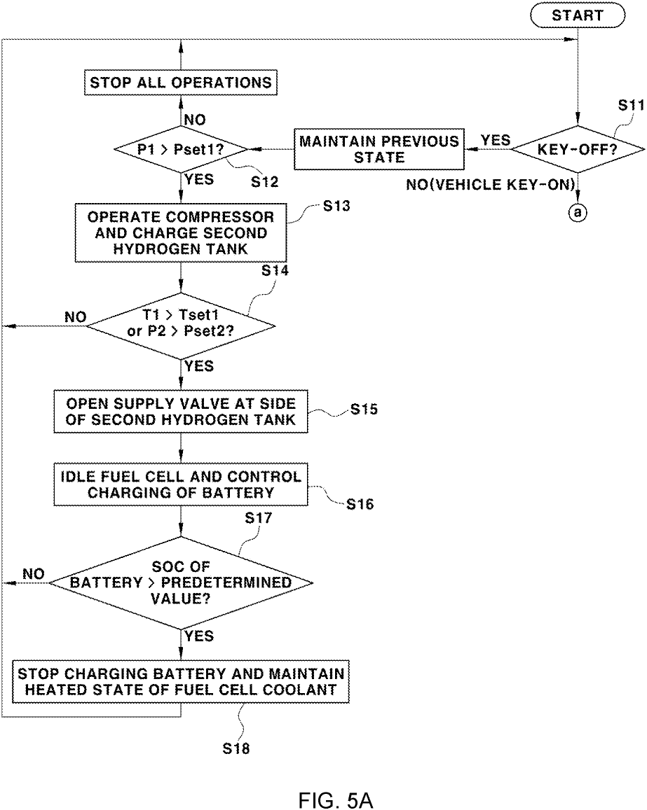

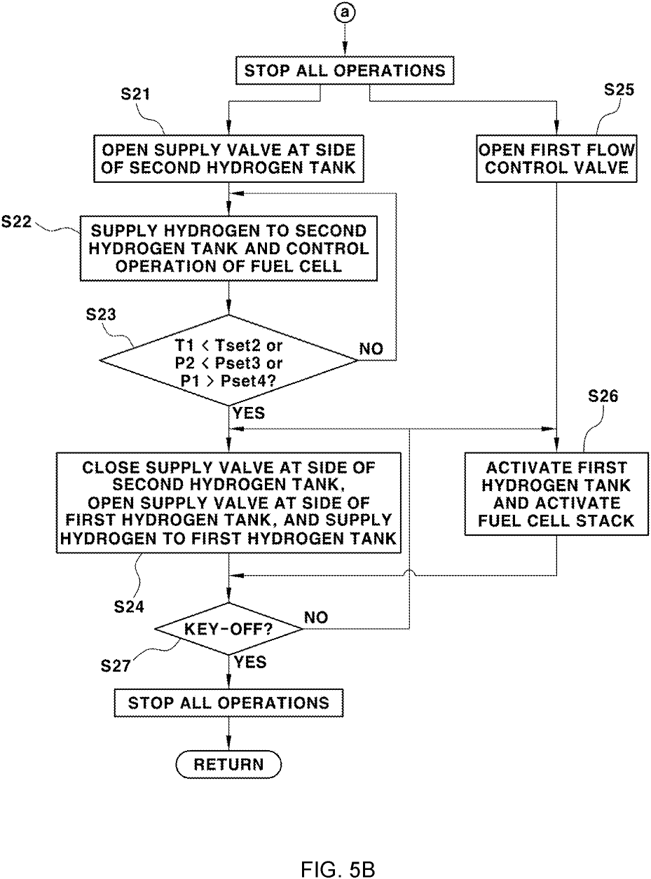

FIG. 3 is a view illustrating a configuration of a boil-off gas treatment system according to an exemplary embodiment of the present disclosure, and FIG. 4 is a view illustrating a coolant circulation path in a fuel cell electric vehicle to which the boil-off gas treatment system according to the embodiment of the present disclosure is applied. In addition, FIGS. 5A and 5B are flowchart illustrating a boil-off gas treatment method according to an exemplary embodiment of the present disclosure.

As illustrated, the boil-off gas treatment system according to the embodiment of the present disclosure includes: a hydrogen storage unit configured to store liquid hydrogen and hydrogen vaporized from a liquid state in a state in which the hydrogen storage unit is charged with hydrogen used as fuel for a fuel cell stack 33; and a state detector installed in the hydrogen storage unit and configured to detect an internal state of a storage space

In this case, the hydrogen storage unit may include: a first hydrogen tank 10 charged with injected hydrogen used as fuel for the fuel cell stack 33, the first hydrogen tank 10 being configured to store the hydrogen in a liquid state; and a second hydrogen tank 20 configured to define a storage space in which the vaporized hydrogen is stored, and store the vaporized hydrogen moved from the interior of the first hydrogen tank 10 through hydrogen lines 9.

In addition, the boil-off gas treatment system according to the embodiment of the present disclosure may include: a pressure relief valve (PRV) 12 installed on the first hydrogen tank 10; a compressor 61 installed at an outlet side of the pressure relief valve 12; a supply valve 63 installed at an outlet side of the second hydrogen tank 20; and a pressure regulator 23 installed at an outlet side of the supply valve 63. In this case, the second hydrogen tank 20 is installed at an outlet side of the compressor 61.

Further, the boil-off gas treatment system according to the embodiment of the present disclosure may further include state detectors including: a first pressure sensor 11 configured to detect a pressure of vaporized hydrogen in the first hydrogen tank 10; a temperature sensor 21 configured to detect a temperature in the second hydrogen tank 20; and a second pressure sensor 22 configured to detect a pressure of hydrogen in the second hydrogen tank 20. Among the state detectors, the temperature sensor 21 and the second pressure sensor 22 are the state detectors configured to detect the internal states of the second hydrogen tank 20 which is a storage space that stores the vaporized hydrogen.

The first hydrogen tank 10 may be a typical hydrogen tank mounted to store the hydrogen which is fuel gas for a fuel cell electric vehicle. The first hydrogen tank 10 may be a hydrogen tank in the related art which is charged with liquid hydrogen injected through a hydrogen charging nozzle at the time of charging the first hydrogen tank with the hydrogen at a hydrogen charging station after connecting the hydrogen charging nozzle of the hydrogen charging station to a hydrogen charging port of the vehicle.

A supply valve 62 may be installed at the outlet side of the first hydrogen tank 10 connected to the fuel cell stack through the hydrogen line. Therefore, the hydrogen stored in the first hydrogen tank 10 may be supplied to the fuel cell stack 33 of the vehicle through the supply valve 62 installed at the outlet side. The supply valve 62 may be an electronic valve configured to be opened or closed under the control of a controller 60 and adjust a flow rate.

Similar to a typical case, the hydrogen with which the first hydrogen tank 10 is charged at the hydrogen charging station is stored in a liquid state in the first hydrogen tank 10. In this case, gaseous hydrogen vaporized from the liquid hydrogen is also present in the first hydrogen tank 10.

The pressure relief valve (PRV) 12 may be a valve configured to discharge boil-off gas in the first hydrogen tank 10 to the outside when a pressure in the first hydrogen tank 10 is raised to a predetermined pressure or higher because of the gaseous hydrogen continuously vaporized from the liquid hydrogen in the first hydrogen tank 10, i.e., the boil-off gas (BOG). The pressure relief valve 12 keeps the pressure in the first hydrogen tank 10 in a safe state.

In the embodiment of the present disclosure, the first pressure sensor 11 may be provided at a side of the first hydrogen tank 10 and serves to detect a pressure of the vaporized hydrogen in the first hydrogen tank 10. The first pressure sensor 11 may be installed at a position of a front end of the pressure relief valve 12 (at a position of an upstream side based on a hydrogen movement direction) and serve to detect a pressure of the vaporized hydrogen in the first hydrogen tank 10, the pressure of the vaporized hydrogen being applied to the pressure relief valve 12. For example, the first pressure sensor 11 may be installed at an upper side in the first hydrogen tank 10.

The compressor 61 may compress the vaporized hydrogen, which is discharged from the pressure relief valve 12, into high-temperature and high-pressure gaseous hydrogen a high temperature and a high pressure and supplies the compressed hydrogen to the second hydrogen tank 20. In the embodiment of the present disclosure, the compressor 61 may be a small-scale electric compressor that operates by receiving power from a high-voltage battery 50 mounted in the vehicle.

The second hydrogen tank 20 may be a separate tank configured to be supplied with and store high-temperature, high-pressure gaseous hydrogen compressed by the compressor 61. The temperature sensor 21 configured to detect an internal temperature and the second pressure sensor 22 configured to detect an internal pressure may be installed in the second hydrogen tank 20.

In addition, like the supply valve 62 installed at the outlet side of the first hydrogen tank 10, the supply valve 63 installed at the outlet side of the second hydrogen tank 20 may be an electronic valve configured to be opened or closed under the control of the controller 60 and adjust a flow rate.

The gaseous hydrogen stored in the second hydrogen tank 20 may be supplied through the supply valve 63 and passes through the high-pressure regulator (HPR) 23. In this case, the gaseous hydrogen may be supplied to the fuel cell stack 33 after a pressure of the gaseous hydrogen is adjusted to a predetermined pressure by the pressure regulator 23. The pressure regulator 23 may serve to adjust the pressure of the hydrogen supplied from the second hydrogen tank 20 to a predetermined pressure required for the fuel cell stack 33.

In addition, tubes for transmitting and supplying the hydrogen, i.e., the hydrogen lines 9 may be connected between the pressure relief valve 12, the compressor 61, and the second hydrogen tank 20 and between the fuel cell stack 33, the pressure regulator 23, and the supply valve 63 at the side of the second hydrogen tank 20.

In this case, the hydrogen line 9 for transmitting and supplying the hydrogen may be connected between the fuel cell stack 33 and the supply valve 62 at the side of the first hydrogen tank 10. A pressure regulator 13 configured to adjust a hydrogen supply pressure may also be installed in the hydrogen line 9 between the fuel cell stack 33 and the supply valve 62 at the side of the first hydrogen tank 10.

In addition, FIG. 3 illustrates that the outlet side of the first hydrogen tank 10 and the outlet side of the second hydrogen tank 20 are independently connected to the fuel cell stack 33 through the hydrogen lines 9, and the regulators 13 and 23 may be installed in the hydrogen lines separately connected. However, a hydrogen line may branch off from the first hydrogen tank 10 and the second hydrogen tank 20 and connect to the fuel cell stack 33, and a single common regulator may be installed in the hydrogen line 9 disposed in a section before the hydrogen line 9 branches.

In the embodiment of the present disclosure, a check valve 64 may be installed in the hydrogen line 9 disposed at the outlet side of the compressor 61. The check valve 64 prevents the hydrogen in the second hydrogen tank 20 charged with the high-pressure hydrogen from flowing reversely to the compressor 61.

Meanwhile, a publicly-known fuel cell system 1 may include a thermal management system configured to control a temperature of the fuel cell stack 33. The thermal management system has a configuration of a coolant-cooled system using a coolant. The coolant-cooled system maintains and controls a stack temperature to an appropriate temperature by cooling or warming up the fuel cell stack by using the coolant according to an operating condition of the fuel cell system.

As illustrated in FIG. 4, the thermal management system may include: a coolant channel (not illustrated) provided in the fuel cell stack 33 and configured to allow the coolant to pass therethrough; a radiator 35 and a cooling fan 36 configured to dissipate heat of the coolant to the outside; a coolant line 37 connected between the fuel cell stack 33 and the radiator 35 so that the coolant circulates in the coolant line 37; a water pump 32 configured to pump the coolant and circulate the coolant along the coolant line 37; and a coolant heater 34 configured to heat the coolant that circulates along the coolant line 37.

In addition, in the present disclosure, the coolant line 37 may be connected to the first hydrogen tank 10, and the first hydrogen tank 10 has a coolant passageway (not illustrated) through which the coolant may pass. In this case, the coolant line 37 may be connected to an inlet and an outlet of the coolant passageway provided in the first hydrogen tank 10.

In addition, a bypass line 38 may branch off from the coolant line 37 and may be connected between a position of a front end of the first hydrogen tank 10 (a position of an upstream side based on a coolant flow direction) and a position of a rear end of the first hydrogen tank 10 (a position of a downstream side based on the coolant flow direction). A flow control valve 39, which is a 3-way valve, may be installed at a position at which the bypass line 38 branches off from the coolant line 37. The bypass line 38 and the flow control valve 39 may serve to allow the coolant to bypass the first hydrogen tank 10 so that the coolant does not pass through the first hydrogen tank 10.

In the following description, the bypass line 38 may be referred to as a first bypass line, and the flow control valve 39 may be referred to as a first flow control valve.

The first flow control valve 39 may be an electronic valve configured to be opened or closed under the control of the controller 60 and adjust a flow rate. The first flow control valve 39 may be controlled to selectively open one of the flow path at the side of the first hydrogen tank 10 and the flow path at the side of the first bypass line 38 on the basis of a control signal of the controller 60. Therefore, the coolant having passed through the fuel cell stack 33 may circulate in a path passing through the first hydrogen tank 10 or circulate in a path passing through the first bypass line 38 without passing through the first hydrogen tank 10.

As described below, the controller 60 may control an operation of the first flow control valve 39 so that the coolant passes through the first hydrogen tank 10 only in a state in which the vehicle is turned on (key-on state). That is, in state in which the vehicle is turned on, the controller 60 may control the first flow control valve 39 to open the flow path at the side of the first hydrogen tank 10 and close the flow path at the side of the first bypass line 38. In this case, the coolant may circulate in a path further passing through the first hydrogen tank 10.

In addition, another bypass line 40 may branch off from the coolant line 37 and may be connected between a position of a front end of the radiator 35 (a position of an upstream side based on the coolant flow direction) and a position of a rear end of the radiator 35 (a position of a downstream side based on the coolant flow direction). A flow control valve 41 , which is a separate 3-way valve, may be installed at a position at which the bypass line 40 branches off from the coolant line 37. The bypass line 40 and the flow control valve 41 may serve to allow the coolant to bypass the radiator 35 so that the coolant does not pass through the radiator 35.

In the following description, the bypass line 40 configured to connect the front and rear ends of the radiator 35 may be referred to as a second bypass line, and the separate flow control valve 41 may be referred to as a second flow control valve.

The second flow control valve 41 may be an electronic valve configured to be opened or closed under the control of the controller 60 and adjust a flow rate. The second flow control valve 41 may be controlled to selectively open one of the flow path at the side of the radiator 35 and the flow path at the side of the second bypass line 40 on the basis of a control signal of the controller 60. Therefore, the coolant having passed through the fuel cell stack 33 may circulate in a path passing through the radiator 35 or circulate in a path passing through the second bypass line 40 without passing through the radiator 35.

Therefore, in the entire thermal management system, the coolant may circulate through the components connected by the coolant line 37, i.e., circulate through the path including a reservoir tank 31, the water pump 32, the fuel cell stack 33, the first flow control valve 39, the first hydrogen tank 10 or the first bypass line 38, the coolant heater 34, the second flow control valve 41, and the radiator 35 or the second bypass line 40. In this case, the coolant heater 34 may be an electric heater that operates by receiving power from the battery 50.

The configuration of the boil-off gas treatment system according to the embodiment of the present disclosure has been described in detail above. Hereinafter, a boil-off gas treatment method will be described below in detail with reference to FIGS. 5A and 5B.

First, in the present disclosure, a mechanism of converting, storing, recovering, and circulating energy will be described. The vaporized hydrogen (boil-off gas) may be discharged to the outside through the pressure relief valve 12 from the interior of the first hydrogen tank 10, such that the pressure in the first hydrogen tank 10 is stably maintained. At the same time, the vaporized hydrogen discharged through the pressure relief valve 12 may be compressed into high-pressure gaseous hydrogen by the compressor 61, and then the high-pressure gaseous hydrogen may be stored in the second hydrogen tank 20, which is a separate hydrogen tank.

Next, the gaseous hydrogen stored in the second hydrogen tank 20 may be supplied to the fuel cell stack 33 and used as fuel gas. In particular, when the vehicle is turned on (key-on), the gaseous hydrogen stored in the second hydrogen tank 20 may be first supplied to the fuel cell stack 33 and used as fuel gas. This means that the gaseous hydrogen in the second hydrogen tank 20 may be consumed as fuel first at the time of turning on the vehicle so that the second hydrogen tank 20 is emptied.

In addition, electrical energy stored in the battery 50 may be consumed as the compressor 61 operates during the process of storing the gaseous hydrogen in the second hydrogen tank 20. However, the gaseous hydrogen, which was removed in the related art, may be supplied to and stored in the second hydrogen tank 20 by the operation of the compressor 61 and then used as fuel gas in the fuel cell stack 33. This means that the consumed electrical energy is stored and recovered as chemical energy.

In addition, in the state in which the vehicle is turned on, the coolant, which is heated by heat generated by the fuel cell stack 33, may pass through the fuel cell stack 33 and the first hydrogen tank 10, such that the fuel cell stack 33 and the first hydrogen tank 10 may be quickly warmed up and maintained at an appropriate temperature. That is, electrical energy may be converted into thermal energy by heating the coolant, and then both the fuel cell stack 33 and the first hydrogen tank 10 may be activated by thermal energy of the coolant.

Therefore, it is possible to improve cold startability by quickly warming up the fuel cell stack 33 by using the heated coolant in the state in which the vehicle and the fuel cell system 1 are turned on. In a state in which the operation of the fuel cell system 1 is started, thermal energy is transferred to the first hydrogen tank 10 by means of the heated coolant, and the first hydrogen tank 10 is boiled, such that hydrogen may be more smoothly vaporized in the first hydrogen tank 10 and the vaporized hydrogen may be more smoothly supplied to the fuel cell stack 33.

Since electrical energy is recovered as thermal energy by heating the coolant as described above, it is possible to use the thermal energy as activation energy of the fuel cell stack 33 and the first hydrogen tank 10 without consuming separate energy.

As a result, in the present disclosure, the gaseous hydrogen, which was removed in the related art, may be used to charge the battery 50 or heat the coolant to activate the fuel cell stack 33 and the first hydrogen tank 10. Therefore, it is possible to improve cold startability of the vehicle and efficiently use energy. In addition, the present disclosure does not discharge hydrogen into the atmosphere and thus can meet regulations, ensure safety, and contribute to the commercialization of the hydrogen fuel cell electric vehicle.

Hereinafter, a process of treating boil-off gas will be described in more detail in a stepwise manner with reference to FIGS. 5A and 5B.

First, in step S11, when the vehicle and the fuel cell system 1 are turned off (key-off state), a pressure P1 of the vaporized hydrogen in the first hydrogen tank 10 detected by the first pressure sensor 11 may be compared with a preset first set pressure Pset1 (e.g., 13 barg) (S12). In this case, when the pressure P1 of the vaporized hydrogen in the first hydrogen tank 10 is equal to or lower than the first set pressure Pset1 (P1 <_ Pset1), all the operations of the fuel cell system and the boil-off gas treatment system are kept stopped in the state in which the vehicle is turned off.

In contrast, when the pressure P1 of the vaporized hydrogen in the first hydrogen tank 10 is higher than the first set pressure Pset1 (P1 > Pset1), the compressor 61 may be operated by the controller 60 (S13). In this case, the controller 60 allows the compressor to be operated by power of the battery 50 by allowing the power of the battery 50 to be applied to the compressor 61.

In addition, when the pressure P1 of the vaporized hydrogen in the first hydrogen tank 10 is higher than the first set pressure Pset1 (P1 > Pset1 ), the vaporized hydrogen in the first hydrogen tank 10 may be discharged through the pressure relief valve 12. In this case, the discharged vaporized hydrogen is compressed into a high temperature and a high pressure gaseous hydrogen by the compressor 61 and the gaseous hydrogen is transmitted to the second hydrogen tank 20, such that the second hydrogen tank 20 is charged with the gaseous hydrogen (S13).

Thereafter, the controller 60 may compare a temperature T1 in the second hydrogen tank 20 detected by the temperature sensor 21 with a preset first set temperature Tset1 (e.g., 85° C.) and compares a hydrogen pressure P2 in the second hydrogen tank 20 detected by the second pressure sensor 22 with a preset second set pressure Pset2 (e.g., 875 barg) (S14).

In this case, when the temperature T1 in the second hydrogen tank 20 is higher than the first set temperature Tset1 (T1 > Tset1) or the hydrogen pressure P2 in the second hydrogen tank 20 is higher than the second set pressure Pset2 (P1 > Pset2), the controller 60 may open the supply valve 63 (S15) and controls the fuel cell system 1 to idle while the gaseous hydrogen in the second hydrogen tank 20 is supplied to the fuel cell stack 33 (S16).

In addition, the controller 60 may allow the hydrogen supplied from the second hydrogen tank 20 to be used as fuel gas in the fuel cell stack 33 while the fuel cell system 1 idles. In this case, the controller 60 allows the battery 50 in the vehicle to be charged with electrical energy generated by the fuel cell stack 33 (S16).

Thereafter, in step S17, when a state of charge (SOC) value of the battery received from a battery management system (BMS) 51 exceeds a predetermined value (e.g., 99%), the controller 60 may stop the operation of charging the battery 50 and maintains a heated state of the coolant (S18). That is, the controller 60 may maintain the heated state of the coolant by allowing the coolant to be continuously heated by heat generated by the fuel cell stack 33 while the fuel cell system 1 operates or operating the coolant heater 34 by using power generated by the fuel cell stack 33.

In this case, the power generated by the fuel cell stack 33 may be used as power for operating the coolant heater 34, the cooling fan (radiator fan) 36, and the water pump 32 and power for operating auxiliary machinery components such as an air blower or a compressor (not illustrated) that supplies air to the fuel cell stack 33.

In this case, the maintenance of the heated state of the coolant may serve to improve cold startability when the vehicle is turned on (key-on state) later. Further, the maintenance of the heated state of the coolant serves to eliminate the process of warming up the fuel cell stack 33 or shorten warming-up time and starting time of the fuel cell stack. Of course, hydrogen, which is fuel, is continuously consumed because the operation state of the fuel cell stack is maintained while the battery is not charged. In this case, the consumed hydrogen was removed by being discharged into the atmosphere because of an increase in pressure in the first hydrogen tank 10 in the related art.

As described above, the hydrogen, which was removed in the related art, may be used to maintain the heated state of the coolant while maintaining the operation state of the fuel cell. Further, the hydrogen, which was removed in the related art, may be used to provide effects of improving cold startability of the vehicle, shortening starting time, reducing energy consumption during the cold starting, and reducing activation energy, thereby providing an advantage in using waste energy. In addition, among other things, it is possible to ensure safety because the vaporized hydrogen is not discharged into the atmosphere from the interior of the first hydrogen tank 10 in the state in which the vehicle is turned off.

Further, in step S12, when the pressure P1 of the vaporized hydrogen in the first hydrogen tank 10 is equal to or lower than the first set pressure Pset1 (P1 ≤Pset1), the compressor 61 disposed between the first hydrogen tank 10 and the second hydrogen tank 20 may not operate, and the supply valve 63 of the second hydrogen tank 20 is kept closed. In addition, the fuel cell system 1 does not idle, and the process returns to step S11.

In addition, in step S14, when the temperature T1 in the second hydrogen tank 20 is equal to or lower than the first set temperature Tset1 (T1 ≤ Tset1) and the hydrogen pressure P2 in the second hydrogen tank 20 is equal to or lower than the second set pressure Pset2 (P2 ≤ Pset2), the supply valve 63 of the second hydrogen tank 20 may be also kept closed, the fuel cell system 1 may not idle, and the process may return to step S11.

In addition, in step S17, when the state of charge (SOC) of the battery 50 is maintained to be equal to or smaller than a predetermined value while the fuel cell system 1 idles and the battery 50 is charged, the operation of charging the battery 50 may not be stopped, and the process may return to step S11.

Meanwhile, when the vehicle is turned on (key-on state), the gaseous hydrogen stored in the second hydrogen tank 20 may be preferentially supplied as the fuel gas to initiate the operation of the fuel cell system 1. That is, the controller 60 opens the supply valve 63 at the side of the second hydrogen tank 20 to allow the gaseous hydrogen in the second hydrogen tank to be supplied to the fuel cell stack 33, and the controller 60 controls an operation of the fuel cell system 1 (S21 and S22).

During the process of supplying the high-pressure hydrogen stored in the second hydrogen tank 20 to the fuel cell stack 33 as described above, the pressure of the high-pressure hydrogen discharged from the second hydrogen tank 20 may be adjusted to an appropriate supply pressure (e.g., a predetermined pressure of 13 barg or lower) while the hydrogen passes through the pressure regulator 23, and then the hydrogen is supplied to the fuel cell stack 33. The same applies to the idle operation in step S16.

When the vehicle is turned on (key-on state) in the heated state of the coolant in step S18 during the treatment process in FIG. 5A, it is possible to reduce warming-up and activation time of the fuel cell stack 33 and normally operate the fuel cell stack 33 within a short time. Thereafter, the vehicle travels as a motor is operated by power generated by the fuel cell stack 33.

Thereafter, when the temperature T1 in the second hydrogen tank 20 detected by the temperature sensor 21 becomes lower than a preset second set temperature Tset2 (e.g.,-40° C.) (T1 < Tset2) or the hydrogen pressure P2 in the second hydrogen tank 20 becomes lower than a preset third set pressure Pset3 (e.g., 13 barg) (P2 < Pset3) while the gaseous hydrogen in the second hydrogen tank 20 is used as fuel, the controller 60 may close the supply valve 63 at the side of the second hydrogen tank 20 and opens the supply valve 62 at the side of the first hydrogen tank 10 (S23 and S24).

Therefore, the hydrogen stored in the first hydrogen tank 10 may be supplied as fuel gas to the fuel cell stack 33 (S24). Thereafter, the fuel cell system 1 may operate by using, as fuel gas, hydrogen supplied from the first hydrogen tank 10, and the vehicle may travel by using power generated by the fuel cell stack 33.

Since the hydrogen stored in the first hydrogen tank 10 may also pass through the pressure regulator 13 at the time of supplying the hydrogen in the first hydrogen tank 10 to the fuel cell stack 33 as described above, the pressure of the hydrogen may be adjusted to an appropriate supply pressure (e.g., a predetermined pressure of 13 barg or lower) by the pressure regulator and then the hydrogen may be supplied to the fuel cell stack 33.

In addition, the configuration has been described in which the hydrogen in the first hydrogen tank 10 begins to be supplied when the temperature T1 in the second hydrogen tank 20 is lower than the second set temperature Tset2 or the hydrogen pressure P2 in the second hydrogen tank 20 is lower than the third set pressure Pset3. However, even in a case in which the pressure P1 of the vaporized hydrogen in the first hydrogen tank 10 is higher than a fourth set pressure Pset4 (P1 > Pset4) set as a limit value of the internal pressure of the first hydrogen tank 10, the supply valve 63 of the second hydrogen tank 20 may be closed, and the supply valve 62 of the first hydrogen tank 100 may be opened, such that the hydrogen begins to be supplied from the first hydrogen tank 10.

In the present disclosure, the first set pressure Pset1 may be set to an appropriate supply pressure value of the hydrogen supplied to the fuel cell stack 33, and the second set pressure Pset2 may be set to a limit value (e.g., 875 barg) of the internal pressure of the second hydrogen tank 20. In addition, the third set pressure Pset3 may also be set to an appropriate supply pressure value (e.g., 13 barg) of the hydrogen supplied to the fuel cell stack 33, and the first set pressure and the third set pressure may be set to the same pressure value or different pressure values.

In addition, the second hydrogen tank 20 may be a tank having a value of the second set pressure Pset2 as a limit value of the internal pressure and an appropriate range of use defined between the first set temperature Tset1 and the second set temperature Tset2. That is, the first set temperature may be set to an upper limit temperature of an appropriate range of use of the second hydrogen tank 20, and the second set temperature may be set to a lower limit temperature of an appropriate range of use temperature of the second hydrogen tank 20.

Further, when the vehicle is turned on (key-on state) and the fuel cell system 1 begins to operate, the controller 60 may control the first flow control valve 39 to open the flow path at the side of the first hydrogen tank 10 and close the flow path at the side of the first bypass line 38 (S25). Therefore, the coolant passes not only through the coolant channel in the fuel cell stack 33 but also through the coolant passageway in the first hydrogen tank 10, such that the first hydrogen tank 10 is warmed up by the coolant.

As a result, the fuel cell stack and the first hydrogen tank may be activated by the coolant (S26). When the vehicle is turned on (key-on state) in the heated state of the coolant in step S18, the first hydrogen tank 10 may be rapidly warmed up by the coolant in the heated state, the time required to activate the first hydrogen tank 10 in a cold starting condition may be shortened, and activation energy may be reduced.

When the coolant is in the heated state before the vehicle is turned on as described above, energy of the waste gaseous hydrogen (boil-off gas) may be used to activate and rapidly warm up the fuel cell stack 33 and the first hydrogen tank 10 during the cold starting. Therefore, it is possible to improve startability, shorten starting time, and reduce activation energy. For example, the coolant in the heated state may induce rapid warming-up and boiling of the first hydrogen tank 10 under the cold starting condition. Therefore, the liquid hydrogen in the first hydrogen tank 10 may be smoothly vaporized, and the vaporized hydrogen may be smoothly supplied.

Further, the aforementioned operation of the fuel cell system 1 may be continuously performed until the vehicle is turned off. When the vehicle is turned off (S27), the control logic in FIG. 5B returns back to the starting step.

The boil-off gas treatment system and method according to the present disclosure have been described in detail above.

According to the boil-off gas treatment system and method according to the present disclosure, it is possible to use the total amount of boil-off gas as fuel gas without waste, the boil-off gas degrading efficiency in using liquid hydrogen. In addition, the total amount of boil-off gas may be used as fuel gas without discarding or discharging the boil-off gas into the atmosphere by applying a collective control concept to recirculation of hydrogen energy and a vehicle system. Therefore, it is possible to increase a utilization rate of hydrogen, reduce energy, implement efficient use, and improve vehicle fuel economy.

In particular, in the related art, the amount of hydrogen exceeding a hydrogen storage limit while the vehicle is parked over a long period of time may be discharged (removed) to the outside, which inevitably causes waste of boil-off gas. In contrast, in the present disclosure, it is possible to increase a utilization rate of energy by energy conversion and alternative storage. In addition, the amount of energy, which exceeds the capacity of storing electrical energy and chemical energy, may be recovered in the form of thermal energy by means of the coolant and used to maintain a temperature condition essential to activation of the fuel cell stack 33 and the first hydrogen tank 10, which makes it possible to maximize a utilization rate of energy. In addition, it is possible to improve startability and shorten starting time under a cold starting condition, and it is possible to ensure safety and meet regulations because the hydrogen is not discharged into the atmosphere.

Although the embodiments of the present disclosure have been described in detail hereinabove, the right scope of the present disclosure is not limited thereto, and many variations and modifications made by those skilled in the art using the basic concept of the present disclosure, which is defined in the following claims, will also belong to the right scope of the present disclosure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A boil-off gas treatment system for a fuel cell electric vehicle, the system comprising:
a hydrogen storage unit configured to separately store 1) liquid hydrogen and 2) hydrogen in a gaseous state;
the hydrogen storage unit comprising a state detector that is configured to detect an internal state of a storage space that stores the gaseous hydrogen;
a controller configured to output a control signal for idling the fuel cell stack by supplying the fuel cell stack with the gaseous hydrogen in the storage space when the internal state of the storage space detected by the state detector satisfies a predetermined condition in a state in which a vehicle is turned off; and
a supply valve installed at an outlet side of the hydrogen storage unit connected to the fuel cell stack, the supply valve being configured to be opened on the basis of a control signal outputted by the controller in order to supply the gaseous hydrogen when the fuel cell stack idles.

2. The system of claim 1 wherein the gaseous hydrogen is vaporized from hydrogen in the liquid state.

3. The system of claim 1, wherein the hydrogen storage unit comprises:
a first hydrogen tank configured to be charged with injected hydrogen to be used as fuel for the fuel cell stack, the first hydrogen tank being configured to store the hydrogen in a liquid state; and
a second hydrogen tank configured to define a storage space that stores the gaseous hydrogen, the second hydrogen tank being configured to store the gaseous hydrogen moved from an interior of the first hydrogen tank through a hydrogen line,
wherein the supply valve is installed at an outlet side of the second hydrogen tank connected to the fuel cell stack.

4. The system of claim 3, wherein a pressure relief valve is installed on the first hydrogen tank and discharges the gaseous hydrogen in the first hydrogen tank when a pressure of the gaseous hydrogen in the first hydrogen tank is equal to or higher than a predetermined pressure, and an outlet side of the pressure relief valve is connected to the second hydrogen tank through the hydrogen line.

5. The system of claim 3, wherein a compressor is installed in the hydrogen line connected from the first hydrogen tank to the second hydrogen tank, and the compressor is controlled by the controller, and compresses hydrogen discharged from the first hydrogen tank and transmits the compressed hydrogen to the second hydrogen tank while operating.

6. The system of claim 5, wherein a first pressure sensor is installed in the first hydrogen tank and detects a pressure of hydrogen vaporized in the first hydrogen tank, and the controller operates the compressor so that hydrogen discharged from the first hydrogen tank is transmitted to the second hydrogen tank when a pressure of the vaporized hydrogen in the first hydrogen tank detected by the first pressure sensor is higher than a preset first set pressure.

7. The system of claim 1, wherein the state detector comprises:
a temperature sensor configured to detect a temperature in the storage space configured to store the vaporized hydrogen; and
a second pressure sensor configured to detect a pressure of the vaporized hydrogen in the storage space.

8. The system of claim 7, wherein when at least one of the predetermined conditions including a condition in which a temperature in the storage space detected by the temperature sensor is higher than a preset first set temperature and a condition in which a pressure of the vaporized hydrogen in the storage space detected by the second pressure sensor is higher than a preset second set pressure is satisfied, the controller opens the supply valve, controls an idling operation of the fuel cell stack using, as fuel, hydrogen supplied from the storage space of the hydrogen storage unit, and performs control so that a battery is charged with power generated by the fuel cell stack.

9. The system of claim 8, wherein when a state of charge (SOC) of the battery exceeds a predetermined value, the controller stops charging the battery, maintains an idling operation state of the fuel cell stack, and maintains a heated state of a coolant circulating through the fuel cell stack.

10. The system of claim 3, wherein when the vehicle is turned on, the controller opens the supply valve and controls an operation of the fuel cell stack using, as fuel, hydrogen supplied from the second hydrogen tank.

11. The system of claim 10, wherein the state detector comprises:
a temperature sensor configured to detect a temperature in the storage space configured to store the gaseous hydrogen; and
a second pressure sensor configured to detect a pressure of the gasepous hydrogen in the storage space, and
wherein when a temperature in the second hydrogen tank detected by the temperature sensor is lower than a preset second set temperature or a pressure of the hydrogen in the second hydrogen tank detected by the second pressure sensor is lower than a preset third set pressure, the controller closes the supply valve installed at the outlet side of the second hydrogen tank, opens a supply valve installed at an outlet side of the first hydrogen tank, and controls an operation of the fuel cell stack using, as fuel, hydrogen supplied from the first hydrogen tank.

12. The system of claim 11, wherein when the vehicle is turned on, the controller warms up the first hydrogen tank by means of a coolant by controlling a flow control valve so that the coolant passes through a coolant passageway in the first hydrogen tank.

13. The boil-off gas treatment system of claim 11, wherein a first pressure sensor is installed in the first hydrogen tank and detects a pressure of the vaporized hydrogen in the first hydrogen tank, and
wherein when a pressure of the vaporized hydrogen in the first hydrogen tank detected by the first pressure sensor is higher than a fourth set pressure set as a limit value of an internal pressure of the first hydrogen tank, the controller closes the supply valve at the outlet side of the second hydrogen tank, opens the supply valve at the outlet side of the first hydrogen tank, and controls the operation of the fuel cell stack using, as fuel, the hydrogen supplied from the first hydrogen tank.

14. A boil-off gas treatment method for a fuel cell electric vehicle, the method comprising:
storing hydrogen vaporized from liquid hydrogen in a separate storage space of a hydrogen storage unit;
detecting, by a state detector, an internal state of the storage space that stores the vaporized hydrogen;
outputting, by a controller, a control signal for idling the fuel cell stack by supplying the fuel cell stack with the vaporized hydrogen in the storage space when the internal state of the storage space detected by the state detector satisfies a predetermined condition in a state in which a vehicle is turned off; and
opening a supply valve installed at an outlet side of the storage space connected to the fuel cell stack and idling the fuel cell stack by hydrogen supplied from the storage space on the basis of the control signal outputted from the controller.

15. The boil-off gas treatment method of claim 14, wherein the hydrogen storage unit comprises:
a first hydrogen tank configured to be charged with injected hydrogen to be used as fuel for the fuel cell stack, the first hydrogen tank being configured to store the hydrogen in a liquid state; and
a second hydrogen tank configured to define a storage space that stores the vaporized hydrogen, the second hydrogen tank being configured to store the vaporized hydrogen moved from an interior of the first hydrogen tank through a hydrogen line,
wherein the supply valve is installed at an outlet side of the second hydrogen tank connected to the fuel cell stack.

16. The boil-off gas treatment method of claim 15, wherein the storing of the vaporized hydrogen in the separate storage space of the hydrogen storage unit comprises:
discharging the vaporized hydrogen in the first hydrogen tank through a pressure relief valve installed on the first hydrogen tank when a pressure of the vaporized hydrogen in the first hydrogen tank is equal to or higher than a predetermined pressure; and
storing hydrogen discharged through the pressure relief valve and moved to the second hydrogen tank through the hydrogen line.

17. The boil-off gas treatment method of claim 15, wherein a compressor is installed in the hydrogen line connected from the first hydrogen tank to the second hydrogen tank, the compressor is controlled by the controller, and compresses hydrogen discharged from the first hydrogen tank and transmits the compressed hydrogen to the second hydrogen tank while operating, a first pressure sensor is installed in the first hydrogen tank and detects a pressure of the vaporized hydrogen vaporized in the first hydrogen tank, and the controller operates the compressor so that hydrogen discharged from the first hydrogen tank is transmitted to the second hydrogen tank when a pressure of the vaporized hydrogen in the first hydrogen tank detected by the first pressure sensor is higher than a preset first set pressure.

18. The boil-off gas treatment method of claim 14, wherein the state detector comprises:
a temperature sensor configured to detect a temperature in the storage space configured to store the vaporized hydrogen; and
a second pressure sensor configured to detect a pressure of the vaporized hydrogen in the storage space.

19. The boil-off gas treatment method of claim 18, wherein when at least one of the predetermined conditions including a condition in which a temperature in the storage space detected by the temperature sensor is higher than a preset first set temperature and a condition in which a pressure of the vaporized hydrogen in the storage space detected by the second pressure sensor is higher than a preset second set pressure is satisfied, the controller opens the supply valve, controls an idling operation of the fuel cell stack using, as fuel, hydrogen supplied from the storage space of the hydrogen storage unit, and performs control so that a battery is charged with power generated by the fuel cell stack.

20. The boil-off gas treatment method of claim 19, wherein when a state of charge (SOC) of the battery exceeds a predetermined value, the controller stops charging the battery, maintains an idling operation state of the fuel cell stack, and maintains a heated state of a coolant circulating through the fuel cell stack; and/or
when the vehicle is turned on, the controller opens the supply valve and controls an operation of the fuel cell stack using, as fuel, hydrogen supplied from the second hydrogen tank; and/or
wherein the state detector comprises:
a temperature sensor configured to detect a temperature in the storage space configured to store the vaporized hydrogen; and
a second pressure sensor configured to detect a pressure of the vaporized hydrogen in the storage space, and
wherein when a temperature in the second hydrogen tank detected by the temperature sensor is lower than a preset second set temperature or a pressure of the hydrogen in the second hydrogen tank detected by the second pressure sensor is lower than a preset third set pressure, the controller closes the supply valve installed at the outlet side of the second hydrogen tank, opens a supply valve installed at an outlet side of the first hydrogen tank, and controls an operation of the fuel cell stack using, as fuel, hydrogen supplied from the first hydrogen tank; and/or
wherein when the vehicle is turned on, the controller warms up the first hydrogen tank by means of a coolant by controlling a flow control valve so that the coolant passes through a coolant passageway in the first hydrogen tank; and/or
wherein a first pressure sensor is installed in the first hydrogen tank and detects a pressure of the vaporized hydrogen in the first hydrogen tank, and
wherein when a pressure of the vaporized hydrogen in the first hydrogen tank detected by the first pressure sensor is higher than a fourth set pressure set as a limit value of an internal pressure of the first hydrogen tank, the controller closes the supply valve at the outlet side of the second hydrogen tank, opens the supply valve at the outlet side of the first hydrogen tank, and controls the operation of the fuel cell stack using, as fuel, the hydrogen supplied from the first hydrogen tank.
